(19) United States
(12) Patent Application Publication
(10) Pub. No.: US 2018/0332625 A1
(43) Pub. Date: Nov. 15, 2018

(54) APPARATUSES AND METHODS FOR BEAM SELECTION DURING A PHYSICAL RANDOM ACCESS CHANNEL (PRACH) TRANSMISSION OR RETRANSMISSION

(71) Applicant: MEDIATEK INC., Hsin-Chu (TW)

(72) Inventor: Chiou-Wei TSAI, Hsinchu (TW)

(21) Appl. No.: 15/977,080

(22) Filed: May 11, 2018

Related U.S. Application Data
(60) Provisional application No. 62/505,150, filed on May 12, 2017.

(51) Int. Cl. H04W 74/08; H04B 7/0408

(52) U.S. Cl. CPC H04W 74/0833; H04B 7/0408

(57) ABSTRACT

A UE including a wireless transceiver and a controller is provided. The controller initiate a RACH procedure with the cellular station via the wireless transceiver, and select a Tx beam for a PRACH transmission or a first PRACH retransmission during the RACH procedure according to at least one of the following: a beam correspondence capability indicating whether the UE is able to determine a correspondence between Rx beams and Tx beams of the UE; results of measurements of downlink reference signals; a number of Tx beams of the UE; an estimated path loss to the cellular station; a maximum transmission power of the UE to perform the PRACH transmission or the first PRACH retransmission; a power ramping step configured for the UE to perform the PRACH transmission or the first PRACH retransmission; and a gain of the selected Tx beam.

### CROSS REFERENCE TO RELATED APPLICATIONS

This Application claims priority of U.S. Provisional Application No. 62/505,150, filed on May 12, 2017, the entirety of which is incorporated by reference herein.

### BACKGROUND OF THE APPLICATION

### Field of the Application

The application generally relates to Physical Random Access Channel (PRACH) transmission/retransmission and, more particularly, to apparatuses and methods for beam selection during a PRACH transmission/retransmission.

### Description of the Related Art

The fifth generation (5G) New Radio (NR) technology is an improvement over the fourth generation (4G) Long Term Evolution (LTE) technology, which provides extreme data speeds and capacity by utilizing higher, unlicensed spectrum bands (e.g., above 30 GHz, loosely known as millimeter Wave (mmWave)), for wireless broadband communications. Due to the huge path and penetration losses at millimeter wavelengths, a technique called “beamforming” is employed, and it assumes an important role in establishing and maintaining a robust communication link.

Beamforming generally requires one or more antenna arrays, each comprising a plurality of antennas. By appropriately setting antenna weights that define the contribution of each of the antennas to a transmission or reception operation, it becomes possible to shape the sensitivity of the transmission/reception to a particularly high value in a specific beamformed direction. By applying different antenna weights, different beam patterns can be achieved, e.g., different directive beams can be sequentially employed.

For a transmission (Tx) operation, beamforming may direct the signal towards a receiver of interest. Likewise, during a reception (Rx) operation, beamforming may provide a high sensitivity in receiving a signal originating from a sender of interest. Since transmission power may be anisotropically focused, e.g., into a solid angle of interest, beamforming may provide better link budgets due to lower required Tx power and higher received signal power, when compared to conventional practice, which does not employ beamforming and relies on more or less isotropic transmission.

For example, during a Random Access Channel (RACH) procedure, a User Equipment (UE) may either apply beam switching or apply power ramping for a PRACH retransmission according to the 3GPP specifications for the 5G NR technology. For beam switching, the UE simply switches to a different beam to perform the PRACH retransmission, without increasing the transmission power. For power ramping, the UE stays on the same beam and increases the transmission power to perform the PRACH retransmission.

### BRIEF SUMMARY OF THE APPLICATION

The present application proposes UEs and methods for beam selection during a PRACH transmission/retransmission, allowing UEs to decide whether to apply beam switching (i.e., selects a different beam) or power ramping (i.e., selects the same beam), and to decide which beam to switch to when applying beam switching.

In a first aspect of the application, a User Equipment (UE) comprising a wireless transceiver and a controller is provided. The wireless transceiver is configured to perform wireless transmission and reception to and from a cellular station. The controller is configured to initiate a RACH procedure with the cellular station via the wireless transceiver, and select a Transmission (Tx) beam for a PRACH transmission or a first PRACH retransmission during the RACH procedure according to at least one of the following: a beam correspondence capability indicating whether the UE is able to determine a correspondence between Reception (Rx) beams and Tx beams of the UE; results of measurements of downlink reference signals and Rx beams used for the measurements; a number of Tx beams of the UE; an estimated path loss to the cellular station; a maximum transmission power configured for the UE to perform the PRACH transmission or the first PRACH retransmission; a power ramping step configured for the UE to perform the PRACH transmission or the first PRACH retransmission; and a gain of the selected Tx beam.

In a second aspect of the application, a method for beam selection during a PRACH transmission/retransmission, executed by a UE wirelessly connected to a cellular station, is provided. The method comprises the steps of: initiating a RACH procedure with the cellular station; and selecting a Tx beam for a PRACH transmission or a first PRACH retransmission during the RACH procedure according to at least one of the following: a beam correspondence capability indicating whether the UE is able to determine a correspondence between Rx beams and Tx beams of the UE; results of measurements of downlink reference signals and Rx beams used for the measurements; a number of Tx beams of the UE; an estimated path loss to the cellular station; a maximum transmission power configured for the UE to perform the PRACH transmission or the first PRACH retransmission; a power ramping step configured for the UE to perform the PRACH transmission or the first PRACH retransmission; and a gain of the selected Tx beam.

Other aspects and features of the present application will become apparent to those with ordinarily skill in the art upon review of the following descriptions of specific embodiments of the UEs and the methods for beam selection during a PRACH transmission/retransmission.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the UE 110 according to an embodiment of the application;

FIG. 3 is a flow chart illustrating the method for beam selection during a PRACH transmission/retransmission according to an embodiment of the application;

FIG. 4 is a schematic diagram illustrating the beam selection for a UE with full beam correspondence according to an embodiment of the application;

FIG. 5 is a schematic diagram illustrating the beam selection for a UE with partial beam correspondence according to another embodiment of the application;

FIG. 6 is a schematic diagram illustrating the beam selection for a UE without beam correspondence according to another embodiment of the application;

FIG. 7 is a schematic diagram illustrating the beam selection for a cell-centered UE according to another embodiment of the application; and

FIG. 8 is a schematic diagram illustrating the beam selection for a cell-edge UE according to another embodiment of the application

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

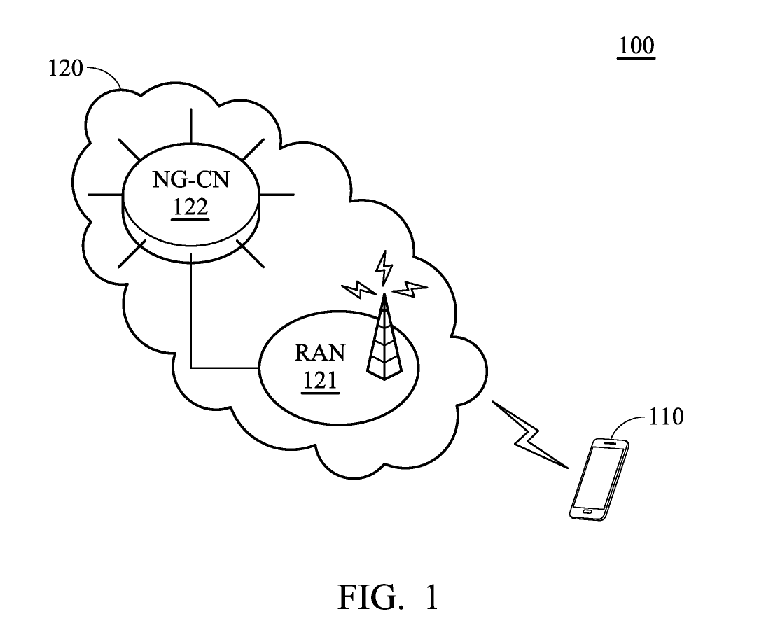

FIG. 1 is a block diagram of a wireless communication environment according to an embodiment of the application. The wireless communication environment 100 includes a User Equipment (UE) 110 and a 5G NR network 120, wherein the UE 110 is wirelessly connected to the 5G NR network 120.

The UE 110 may be a feature phone, a smartphone, a panel Personal Computer (PC), a laptop computer, or any wireless communication device supporting the cellular technology (i.e., the 5G NR technology) utilized by the 5G NR network 120. Particularly, the UE 110 employs the beamforming technique (i.e., supports beam switching) for wireless transmission and/or reception.

The 5G NR network 120 includes a Radio Access Network (RAN) 121 and a Next Generation Core Network (NG-CN) 122.

The RAN 121 is responsible for processing radio signals, terminating radio protocols, and connecting the UE 110 with the NG-CN 122. In addition, the RAN 121 is responsible for periodically broadcasting the minimum SI, and providing the other SI by periodic broadcasting or at the request of the UE 110. The RAN 121 may include one or more cellular stations, such as gNBs, which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

The NG-CN 122 generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

It should be understood that the 5G NR network 120 depicted in FIG. 1 is for illustrative purposes only and is not intended to limit the scope of the application. The application may also be applied to other cellular technologies, such as a future enhancement of the 5G NR technology.

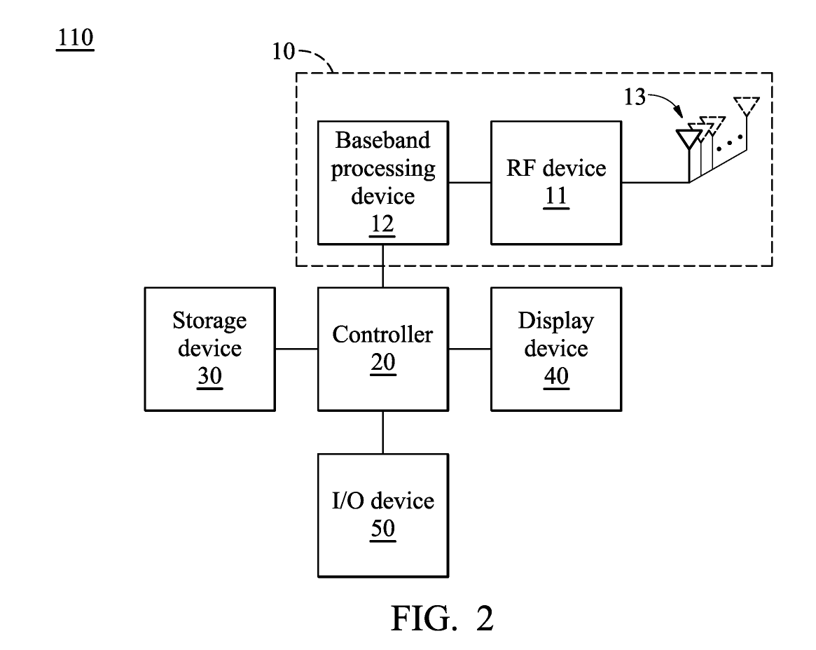

FIG. 2 is a block diagram illustrating the UE 110 according to an embodiment of the application. The UE 110 includes a wireless transceiver 10, a controller 20, a storage device 30, a display device 40, and an Input/Output (I/O) device 50.

The wireless transceiver 10 is configured to perform wireless transmission and reception to and from the RAN 121. Specifically, the wireless transceiver 10 includes a Radio Frequency (RF) device 11, a baseband processing device 12, and antenna(s) 13, wherein the antenna(s) 13 may include one or more antennas for beamforming. The baseband processing device 12 is configured to perform baseband signal processing and control the communications between subscriber identity card(s) (not shown) and the RF device 11. The baseband processing device 12 may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device 11 may receive RF wireless signals via the antenna(s) 13, convert the received RF wireless signals to baseband signals, which are processed by the baseband processing device 12, or receive baseband signals from the baseband processing device 12 and convert the received baseband signals to RF wireless signals, which are later transmitted via the antenna(s) 13. The RF device 11 may also contain multiple hardware devices to perform radio frequency conversion. For example, the RF device 11 may include a mixer to multiply the baseband signals with a carrier oscillated in the radio frequency of the supported cellular technologies, wherein the radio frequency may be any radio frequency (e.g., 30 GHz-300 GHz for mmWave) utilized in the 5G NR technology, or another radio frequency, depending on the cellular technology in use.

The controller 20 may be a general-purpose processor, a Micro Control Unit (MCU), an application processor, a Digital Signal Processor (DSP), or the like, which includes various circuits for providing the functions of data processing and computing, controlling the wireless transceiver 10 for wireless communications with the RAN 121, storing and retrieving data (e.g., program code) to and from the storage device 30, sending a series of frame data (e.g. representing text messages, graphics, images, etc.) to the display device 40, and receiving/outputting signals from/to the I/O device 50. In particular, the controller 20 coordinates the aforementioned operations of the wireless transceiver 10, the storage device 30, the display device 40, and the I/O device 50 for performing the method for beam selection during a PRACH transmission/retransmission.

In another embodiment, the controller 20 may be incorporated into the baseband processing device 12, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 is a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing instructions and/or program code of applications, communication protocols, and/or the method for beam selection during a PRACH transmission/retransmission.

The display device 40 may be a Liquid-Crystal Display (LCD), a Light-Emitting Diode (LED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users, such as receiving user inputs, and outputting prompts to users.

It should be understood that the components described in the embodiment of FIG. 2 are for illustrative purposes only and are not intended to limit the scope of the application. For example, the UE 110 may include more components, such as a power supply, or a Global Positioning System (GPS) device, wherein the power supply may be a mobile/replaceable battery providing power to all the other components of the UE 110, and the GPS device may provide the location information of the UE 110 for use of some location-based services or applications.

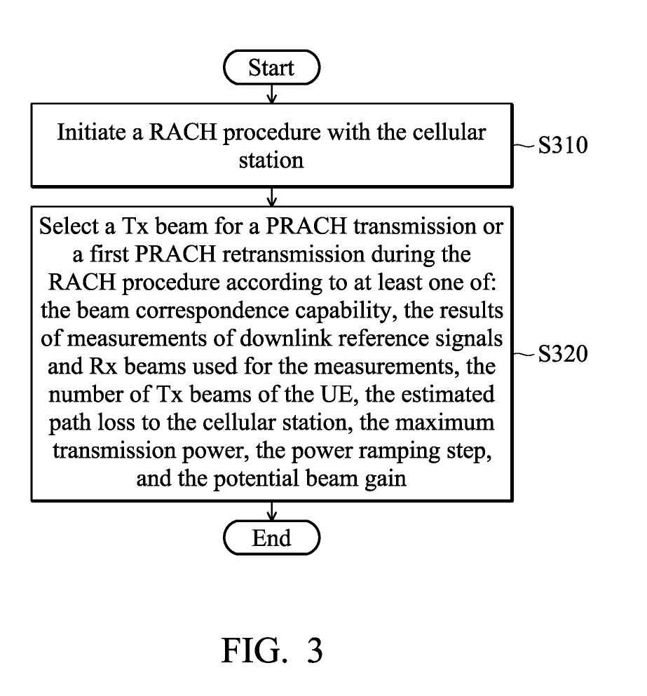

FIG. 3 is a flow chart illustrating the method for beam selection during a PRACH transmission/retransmission according to an embodiment of the application. In this embodiment, the method for beam selection during a PRACH transmission/retransmission is executed by a UE (e.g., the UE 110) which is wirelessly connected to a cellular station (e.g., a gNB or TRP of the RAN 121), and the PRACH transmission/retransmission may refer to transmission/retransmission of the message-1 (i.e., random access preamble) of a RACH procedure.

To begin with, the UE initiates a RACH procedure with the cellular station (step S310). The RACH procedure is also called a random access procedure which is initiated on the Random Access Channel. In general, the RACH procedure may be initiated when the UE requires uplink synchronization with the cellular station for uplink data transfer, or when the cellular station receives downlink data for the UE but the uplink synchronization with the UE is lost, or when the UE does not have an uplink grant to transmit uplink data and the Physical Uplink Control Channel (PUCCH) resources for transmission of Scheduling Request (SR) are released or not configured for the UE.

Next, the UE selects a Transmission (Tx) beam for a PRACH transmission or a first PRACH retransmission during the RACH procedure according to at least one of: the beam correspondence capability, the results of measurements of downlink reference signals and the Rx beams used for the measurements, the number of Tx beams of the UE, the estimated path loss to the cellular station, the maximum transmission power, the power ramping step, and the potential beam gain (i.e., the potential gain of the selected Tx beam) (step S320).

Specifically, the beam correspondence capability indicates whether the UE is able to determine a correspondence between Reception (Rx) beams and Tx beams of the UE. The downlink reference signal may refer to a Channel State Information-Reference Signal (CSI-RS), a Synchronization Signal Block (SSB), or a Physical Broadcast Channel (PBCH) block. The maximum transmission power and the power ramping step are configured by the cellular station for the UE to perform the PRACH transmission or the first PRACH retransmission, wherein the maximum transmission power indicates the maximum transmission power that the UE is allowed to use for the PRACH transmission or the first PRACH retransmission, and the power ramping step is used to increase the transmission power after every failed PRACH transmission/retransmission.

In one embodiment, when the same Tx beam is selected for the PRACH transmission and the first PRACH retransmission, the UE may use a transmission power to perform the PRACH transmission, increase the transmission power to perform the first PRACH retransmission, and increment the power ramping counter by one in response to performing the PRACH transmission and the first PRACH retransmission.

In another embodiment, when different Tx beams are selected for the PRACH transmission and the first PRACH retransmission, the UE may use the same transmission power to perform the PRACH transmission on a first beam and to perform the first PRACH retransmission on a second beam. In addition, the UE increments the power ramping counter by one in response to performing the PRACH transmission and does not increment the power ramping counter by one in response to performing the first PRACH retransmission.

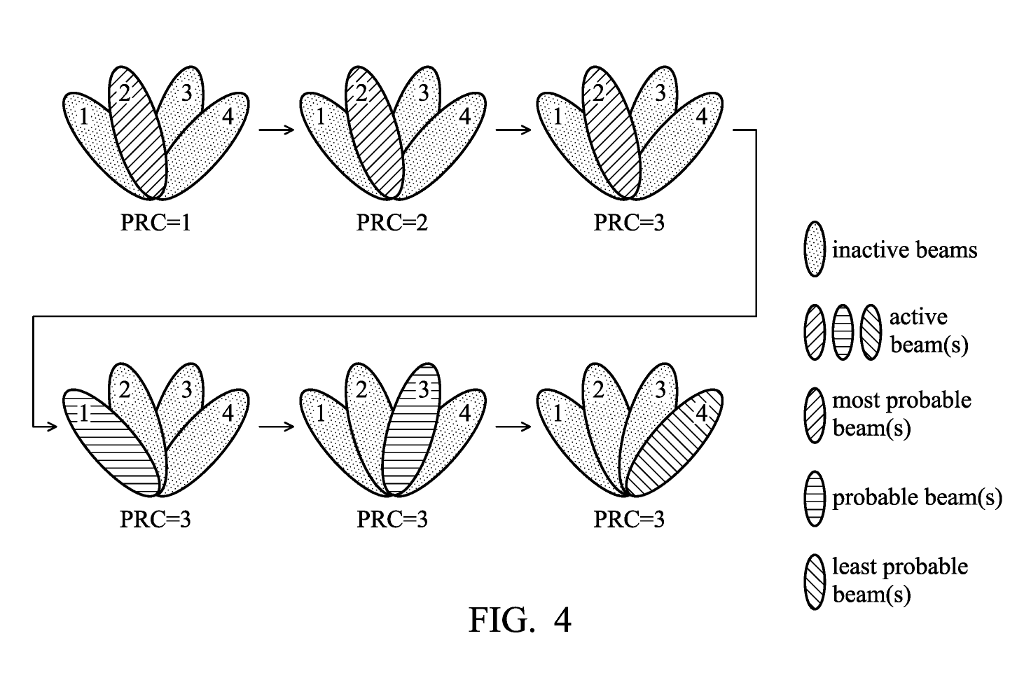

FIG. 4 is a schematic diagram illustrating the beam selection for a UE with full beam correspondence according to an embodiment of the application.

In this embodiment, beam selection is performed according to at least the beam correspondence capability, the measurement results of downlink reference signals, and the Rx beams used for the measurements, wherein the beam correspondence capability indicates that the UE is able to determine the full correspondence between the Rx beams and the Tx beams of the UE, and the measurement results of downlink reference signals indicate that the downlink reference signal received on an Rx beam corresponding to the second Tx beam (denoted with the number ‘2’ in FIG. 4) has the best signal quality. Please note that full beam correspondence refers to that each Rx beam corresponds a Tx beam explicitly.

As shown in FIG. 4, there are four Tx beams in total. Based on the full beam correspondence and the measurement results of downlink reference signals, the second Tx beam is considered most probable Tx beam, the neighboring Tx beams (i.e., the first and third Tx beams) of the second Tx beam are considered probable beams, and the rest Tx beam(s) (i.e., the fourth Tx beam) is/are considered least probable beam(s). The UE stays on the most probable beam (i.e., the second Tx beam) to perform the PRACH retransmissions until the maximum transmission power is reached, and after that, the UE switches to the probable beams first and then the least probable beam for the following PRACH retransmissions.

Specifically, for the PRACH transmission with which the RACH procedure starts, the UE selects the second Tx beam and increments the power ramping counter (denoted as “PRC” in FIG. 4) by one. For the first PRACH retransmission (assuming that the PRACH transmission fails), the UE stays on the same beam, increases the transmission power, and increments the power ramping counter by one. For the second PRACH retransmission (assuming that the first PRACH retransmission fails), the UE stays on the same beam, increases the transmission power, and increments the power ramping counter by one.

It is assumed that the transmission power used for the second PRACH retransmission has reached the maximum transmission power. Subsequently, for the third PRACH retransmission (assuming that the second PRACH retransmission fails), the UE switches from the most probable Tx beam (i.e., the second Tx beam) to one of the probable Tx beams (e.g., the first Tx beam), and keeps the transmission power and the power ramping counter unchanged. For the fourth PRACH retransmission (assuming that the third PRACH retransmission fails), the UE switches to another probable Tx beams (e.g., the third Tx beam), and keeps the transmission power and the power ramping counter unchanged. As last, for the fifth PRACH retransmission (assuming that the fourth PRACH retransmission fails), the UE switches to the least probable Tx beam (i.e., the fourth Tx beam), and keeps the transmission power and the power ramping counter unchanged.

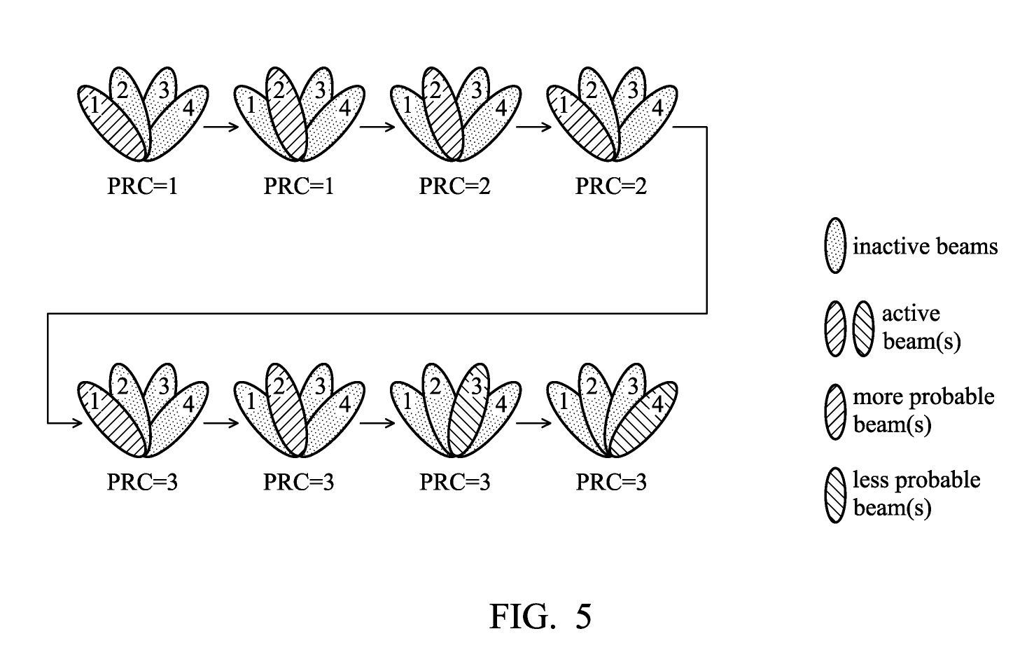

FIG. 5 is a schematic diagram illustrating the beam selection for a UE with partial beam correspondence according to another embodiment of the application.

In this embodiment, beam selection is performed according to at least the beam correspondence capability and the measurement results of downlink reference signals, wherein the beam correspondence capability indicates that the UE is able to determine partial correspondence between the Rx beams and the Tx beams of the UE, and the measurement results of downlink reference signals indicate that the downlink reference signal received on an Rx beam corresponding to either the first or second Tx beam (denoted with the number ‘1’ and ‘2’ in FIG. 5) has the best signal quality. Please note that partial beam correspondence refers to that the correspondence between the Tx beams and the Tx beams may be rough (i.e., an Rx beam may correspond more than one Tx beam.

As shown in FIG. 5, there are four Tx beams in total. Based on the partial beam correspondence and the measurement results of downlink reference signals, the first and second Tx beams are considered more probable Tx beams, and the rest Tx beams (i.e., the third and fourth Tx beams) are considered less probable beams. The UE switches between the more probable beams (i.e., the first and second Tx beams) to perform the PRACH retransmissions until the maximum transmission power is reached, and after that, the UE sweeps from the first Tx beam to the fourth Tx beam for the following PRACH retransmissions.

Specifically, for the PRACH transmission with which the RACH procedure starts, the UE selects one of the more probable beams (e.g., the first Tx beam) and increments the power ramping counter (denoted as “PRC” in FIG. 5) by one. For the first PRACH retransmission (assuming that the PRACH transmission fails), the UE switches to another more probable beam (e.g., the second Tx beam), and keeps the transmission power and the power ramping counter unchanged. For the second PRACH retransmission (assuming that the first PRACH retransmission fails), the UE stays on the same beam, increases the transmission power, and increments the power ramping counter by one. For the third PRACH retransmission (assuming that the second PRACH retransmission fails), the UE switches to another more probable Tx beam (i.e., the first Tx beam), and keeps the transmission power and the power ramping counter unchanged. For the fourth PRACH retransmission (assuming that the third PRACH retransmission fails), the UE stays on the same beam, increases the transmission power, and increments the power ramping counter by one.

It is assumed that the transmission power used for the fourth PRACH retransmission has reached the maximum transmission power. Subsequently, for the following three PRACH retransmission (assuming that the fourth PRACH retransmission fails), the UE switches from the first Tx beam to the second Tx beam, from the second Tx beam to the third Tx beam, and then from the third Tx beam to the fourth Tx beam, while keeping the transmission power and the power ramping counter unchanged.

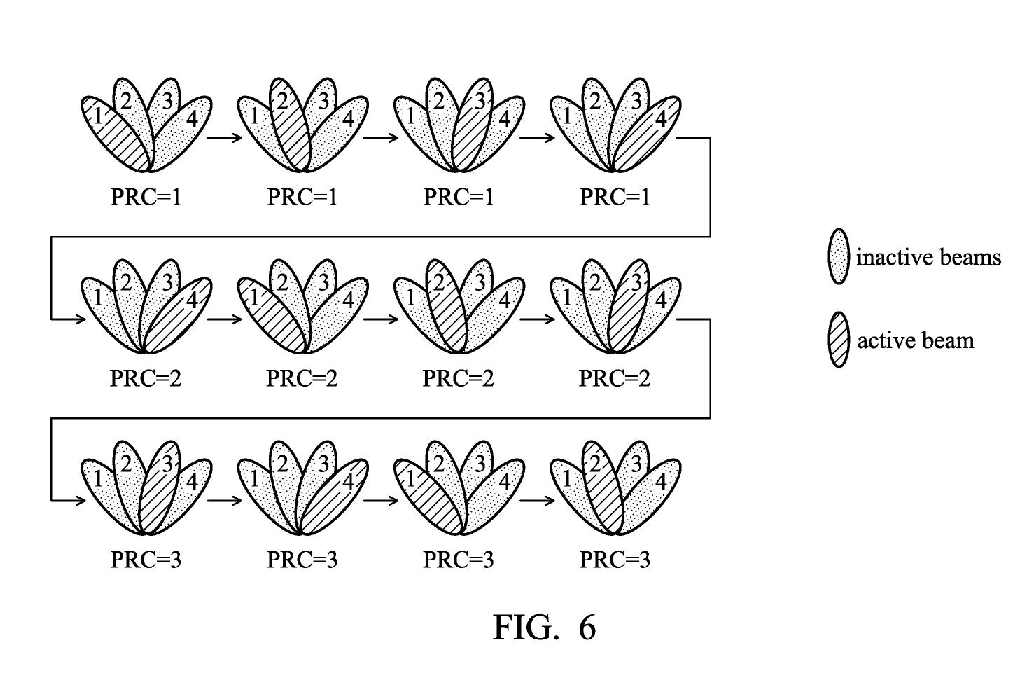

FIG. 6 is a schematic diagram illustrating the beam selection for a UE without beam correspondence according to another embodiment of the application.

In this embodiment, beam selection is performed according to at least the beam correspondence capability which indicates that the UE is unable to determine a correspondence between the Rx beams and the Tx beams of the UE. Since there is no beam correspondence, it may be preferred to conduct beam sweeping before applying power ramping. To further clarify, power ramping may be applied after each round of beam sweeping.

As shown in FIG. 6, there are four Tx beams in total. For the PRACH transmission with which the RACH procedure starts, the UE selects the first Tx beam and increments the power ramping counter (denoted as “PRC” in FIG. 6) by one. For the following three PRACH retransmissions, the UE switches from the first Tx beam to the second Tx beam, from the second Tx beam to the third Tx beam, and then from the third Tx beam to the fourth Tx beam, while keeping the transmission power and the power ramping counter unchanged.

After the third PRACH retransmission, each Tx beam has been tried (i.e., the first round of beam sweeping is completed) with the same transmission power. Subsequently, for the fourth PRACH retransmission, the UE stays on the same beam, further increases the transmission power, and increments the power ramping counter by one. For the following three PRACH retransmissions, the UE switches from the fourth Tx beam to the first Tx beam, from the first Tx beam to the second Tx beam, and then from the second Tx beam to the third Tx beam, while keeping the transmission power and the power ramping counter unchanged.

After the seventh PRACH retransmission, each Tx beam has been tried (i.e., the second round of beam sweeping is completed) with the increased transmission power. Subsequently, for the eighth PRACH retransmission, the UE stays on the same beam, increases the transmission power, and increments the power ramping counter by one. For the following three PRACH retransmissions, the UE switches from the third Tx beam to the fourth Tx beam, from the fourth Tx beam to the first Tx beam, and then from the first Tx beam to the second Tx beam, while keeping the transmission power and the power ramping counter unchanged.

After the eleventh PRACH retransmission, each Tx beam has been tried (i.e., the third round of beam sweeping is completed) with the further increased transmission power.

In view of the forgoing embodiments of FIGS. 4 to 6, it will be appreciated that the present application may increase the number of PRACH retransmissions without violating the PRACH power ramping regulation defined by the 3rd Generation Partnership Project (3GPP) for the 5G NR technology. Also, by increasing the number of PRACH retransmissions, the successful rate of the UE accessing the cellular station may be improved.

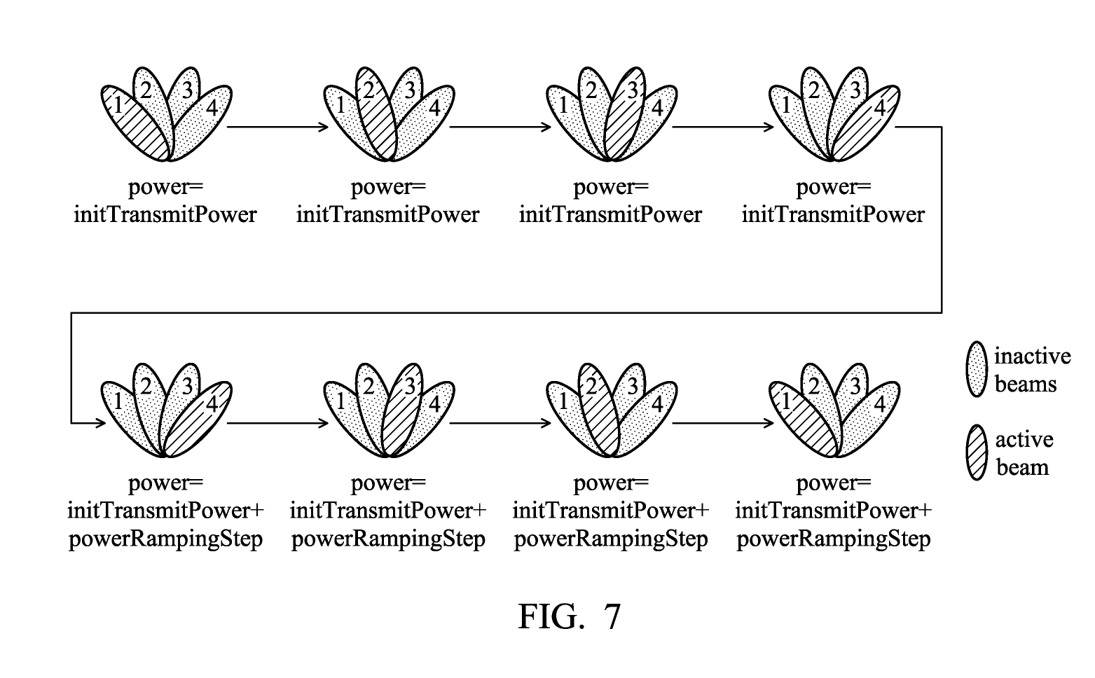

FIG. 7 is a schematic diagram illustrating the beam selection for a cell-centered UE according to another embodiment of the application.

In this embodiment, beam selection is performed according to at least one or more of: the estimated path loss, the maximum transmission power, the power ramping step, and the beam gain of the selected Tx beam, wherein the estimated path loss is less than a predetermined threshold (i.e., the UE may be relatively near the cell center), and/or the power ramping step is less than the beam gain, and/or the number of times to ramp up to the maximum transmission power for the power ramping step and the estimated path loss is greater than the number of Tx beams. Specifically, the estimated path loss may be used to determine the initial transmission power, and the initial transmission power and the power ramping step may be used to determine the number of times to ramp up to the maximum transmission power.

As shown in FIG. 7, there are four Tx beams in total. For the PRACH transmission with which the RACH procedure starts, the UE selects the first Tx beam, uses the initial transmission power to perform the PRACH transmission, and increments the power ramping counter by one. For the following three PRACH retransmissions, the UE switches from the first Tx beam to the second Tx beam, from the second Tx beam to the third Tx beam, and then from the third Tx beam to the fourth Tx beam, while keeping the transmission power and the power ramping counter unchanged.

After the third PRACH retransmission, each Tx beam has been tried (i.e., the first round of beam sweeping is completed) with the initial transmission power. Subsequently, for the fourth PRACH retransmission, the UE stays on the same beam, increases the transmission power, and increments the power ramping counter by one. For the following three PRACH retransmissions, the UE switches from the fourth Tx beam to the third Tx beam, from the third Tx beam to the second Tx beam, and then from the second Tx beam to the first Tx beam (i.e., the beams are swept backward), while keeping the transmission power and the power ramping counter unchanged.

Please note that the embodiment of FIG. 7 prioritizes beam switching over power ramping, especially when the estimated path loss is less than a predetermined threshold, or when the power ramping step is less than the beam gain, or when the number of times to ramp up to the maximum transmission power for the power ramping step and the estimated path loss is greater than the number of Tx beams.

Although not shown, the RACH procedure may continue with more PRACH retransmissions until the maximum transmission power is reached.

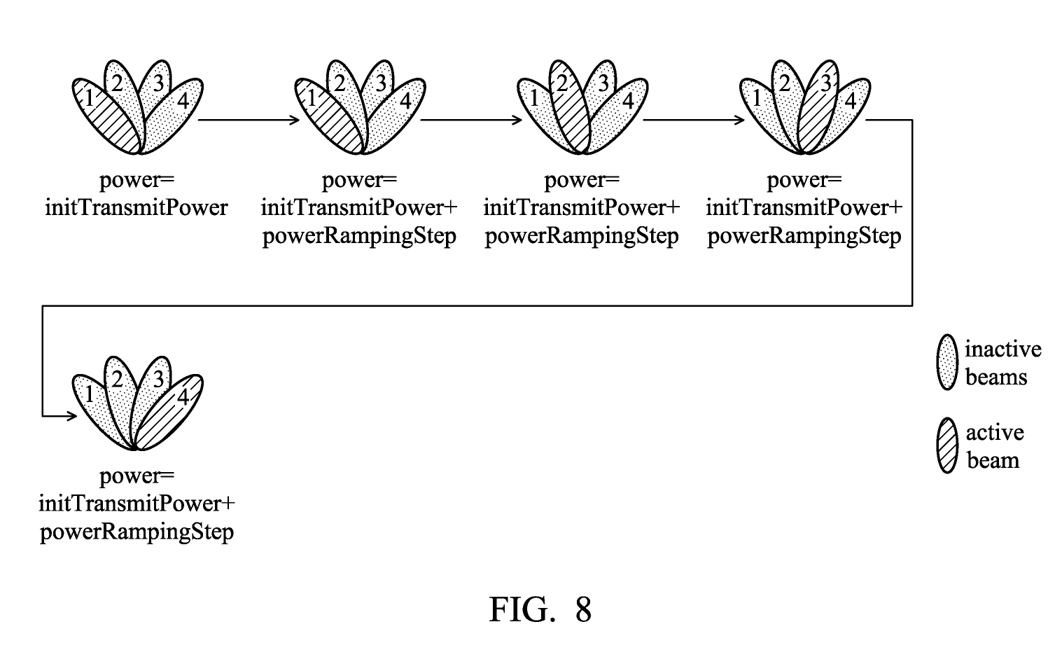

FIG. 8 is a schematic diagram illustrating the beam selection for a cell-edge UE according to another embodiment of the application.

In this embodiment, beam selection is performed according to at least one or more of: the estimated path loss, the maximum transmission power, the power ramping step, and the beam gain of the selected Tx beam, wherein the estimated path loss is greater than a predetermined threshold (i.e., the UE may be relatively near the cell edge), and/or the power ramping step is greater than the beam gain, and/or the number of times to ramp up to the maximum transmission power for the power ramping step and the estimated path loss is smaller than the number of Tx beams. Specifically, the estimated path loss may be used to determine the initial transmission power, and the initial transmission power and the power ramping step may be used to determine the number of times to ramp up to the maximum transmission power.

As shown in FIG. 8, there are four Tx beams in total. For the PRACH transmission with which the RACH procedure starts, the UE selects the first Tx beam, uses the initial transmission power to perform the PRACH transmission, and increments the power ramping counter by one. For the first PRACH retransmission, the UE stays on the same beam, increases the transmission power by the power ramping step, and increments the power ramping counter by one.

Please note that the increased transmission power has reached the maximum transmission power since the initial transmission power may be set relatively high due to the estimated path loss being greater than the predetermined threshold. Subsequently, the UE switches from the first Tx beam to the second Tx beam, from the second Tx beam to the third Tx beam, and then from the third Tx beam to the fourth Tx beam for the following three PRACH retransmissions, while keeping the transmission power and the power ramping counter unchanged.

The embodiment of FIG. 8 prioritizes power ramping over beam switching, especially when the estimated path loss is greater than a predetermined threshold, or when the power ramping step is greater than the beam gain, or when the number of times to ramp up to the maximum transmission power for the power ramping step and the estimated path loss is smaller than the number of Tx beams, except when the UE has reached the maximum transmission power.

In view of the forgoing embodiments of FIGS. 7 and 8, it will be appreciated that the present application allows the UE to access the cellular station as soon as it can without violating the PRACH power ramping regulation defined by the 3GPP for the 5G NR technology, by providing different beam selection patterns for the cell-centered UE and the cell-edge UE. Specifically, for the cell-centered UE, the beam selection pattern indicates the UE to apply beam switching before power ramping. For the cell-edge UE, the beam selection pattern indicates the UE to apply power ramping before beam switching.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A User Equipment (UE), comprising:
a wireless transceiver, configured to perform wireless transmission and reception to and from a cellular station; and
a controller, configured to initiate a Random Access Channel (RACH) procedure with the cellular station via the wireless transceiver, and select a Transmission (Tx) beam for a Physical Random Access Channel (PRACH) transmission or a first PRACH retransmission during the RACH procedure according to at least one of the following:
a beam correspondence capability indicating whether the UE is able to determine a correspondence between Reception (Rx) beams and Tx beams of the UE;
results of measurements of downlink reference signals and Rx beams used for the measurements;
a number of Tx beams of the UE;
an estimated path loss to the cellular station;
a maximum transmission power of the UE to perform the PRACH transmission or the first PRACH retransmission;
a power ramping step configured for the UE to perform the PRACH transmission or the first PRACH retransmission; and
a gain of the selected Tx beam.

2. The UE of claim 1, wherein, when the same Tx beam is selected for the PRACH transmission and the first PRACH retransmission, the controller is further configured to use a transmission power to perform the PRACH transmission via the wireless transceiver, increase the transmission power to perform the first PRACH retransmission via the wireless transceiver, and increment a power ramping counter by one in response to performing the first PRACH retransmission.

3. The UE of claim 1, wherein, when different Tx beams are selected for the PRACH transmission and the first PRACH retransmission, the controller is further configured to use a transmission power to perform the PRACH transmission on a first beam and to perform the first PRACH retransmission on a second beam, and not increment a power ramping counter by one in response to performing the first PRACH retransmission.

4. The UE of claim 3, wherein, when the beam correspondence capability indicates that the UE is unable to determine a correspondence between the Rx beams and the Tx beams of the UE, the UE is further configured to select the second TX beam different from the first TX beam, and the second Tx beam is subsequent to the first Tx beam in a sequential order of beam sweeping or is selected randomly from the Tx beams of the UE.

5. The UE of claim 3, wherein, when the beam correspondence capability indicates that the UE is able to determine a correspondence between the Rx beams and the Tx beams of the UE, the second Tx beam is selected according to the correspondence and the results of the measurements of the downlink reference signals.

6. The UE of claim 1, wherein, when the estimated path loss is greater than a predetermined threshold, the controller is further configured to select the same beam for the PRACH transmission and the first PRACH retransmission, increase a transmission power which is used for the PRACH transmission to perform the first PRACH retransmission via the wireless transceiver, select a different beam for a second PRACH retransmission, and use the increased transmission power to perform the second PRACH retransmission via the wireless transceiver.

7. The UE of claim 1, wherein, when the estimated path loss is less than a predetermined threshold, the controller is further configured to select different beams for the PRACH transmission and the first PRACH retransmission, use the same transmission power to perform the PRACH transmission and the first PRACH retransmission via the wireless transceiver, select the same beam for the first PRACH retransmission and a second PRACH retransmission, and increase the transmission power to perform the second PRACH retransmission via the wireless transceiver.

8. The UE of claim 1, wherein, when the power ramping step is less than the beam gain, the controller is further configured to select different Tx beams for the PRACH transmission and the first PRACH retransmission, and use the same transmission power to perform the PRACH transmission and the first PRACH retransmission via the wireless transceiver.

9. The UE of claim 1, wherein, when the power ramping step is greater than the beam gain, the controller is further configured to select the same Tx beam for the PRACH transmission and the first PRACH retransmission, and increase a transmission power which is used for the PRACH transmission to perform the first PRACH retransmission via the wireless transceiver.

10. The UE of claim 1, wherein, when the number of times to ramp up to the maximum transmission power for the power ramping step and the estimated path loss is greater than the number of Tx beams, the controller is further configured to select different Tx beams for the PRACH transmission and the first PRACH retransmission, and use the same transmission power to perform the PRACH transmission and the first PRACH retransmission via the wireless transceiver.

11. The UE of claim 1, wherein, when the number of times to ramp up to the maximum transmission power for the power ramping step and the estimated path loss is smaller than the number of Tx beams, the controller is further configured to select the same Tx beam for the PRACH transmission and the first PRACH retransmission, and increase a transmission power which is used for the PRACH transmission to perform the first PRACH retransmission via the wireless transceiver.

12. The UE of claim 1, wherein, when the UE has reached the maximum transmission power, the controller is further configured to select different Tx beams for the PRACH transmission and the first PRACH retransmission, and use the same transmission power to perform the PRACH transmission and the first PRACH retransmission via the wireless transceiver.

13. A method for beam selection during a PRACH transmission or retransmission, executed by a UE wirelessly connected to a cellular station, the method comprising:
initiating a RACH procedure with the cellular station; and
selecting a Tx beam for a PRACH transmission or a first PRACH retransmission during the RACH procedure according to at least one of the following:
a beam correspondence capability indicating whether the UE is able to determine a correspondence between Rx beams and Tx beams of the UE;
results of measurements of downlink reference signals and Rx beams used for the measurements;
a number of Tx beams of the UE;
an estimated path loss to the cellular station;
a maximum transmission power of the UE to perform the PRACH transmission or retransmission;
a power ramping step configured for the UE to perform the PRACH transmission or retransmission; and
a gain of the selected Tx beam.

14. The method of claim 13, further comprising:
when determining to increase the transmission power for the first PRACH retransmission,
using a transmission power to perform the PRACH transmission;
increasing the transmission power to perform the first PRACH retransmission; and
incrementing a power ramping counter by one in response to performing the first PRACH retransmission.

15. The method of claim 13, further comprising:
when different Tx beams are selected for the PRACH transmission and the first PRACH retransmission,
using a transmission power to perform the PRACH transmission on a first beam and to perform the first PRACH retransmission on a second beam; and
not incrementing a power ramping counter by one in response to performing the first PRACH retransmission.

16. The method of claim 15, further comprising: when the beam correspondence capability indicates that the UE is unable to determine a correspondence between the Rx beams and the Tx beams of the UE, selecting the second TX beam different from the first TX beam, wherein the second Tx beam is subsequent to the first Tx beam in a sequential order of beam sweeping or is selected randomly from the Tx beams of the UE.

17. The method of claim 15, wherein, when the beam correspondence capability indicates that the UE is able to determine a correspondence between the Rx beams and the Tx beams of the UE, the second Tx beam is selected according to the correspondence and the results of the measurements of the downlink reference signals.

18. The method of claim 13, further comprising:
when the estimated path loss is greater than a predetermined threshold,
selecting the same beam for the PRACH transmission and the first PRACH retransmission;
increasing a transmission power which is used for the PRACH transmission to perform the first PRACH retransmission;
selecting a different beam for a second PRACH retransmission; and
using the increased transmission power to perform the second PRACH retransmission.

19. The method of claim 13, further comprising:
when the estimated path loss is less than a predetermined threshold,
selecting different beams for the PRACH transmission and the first PRACH retransmission;
using the same transmission power to perform the PRACH transmission and the first PRACH retransmission;
selecting the same beam for the first PRACH retransmission and a second PRACH retransmission; and
increasing the transmission power to perform the second PRACH retransmission.

20. The method of claim 13, further comprising:
when the power ramping step is less than the beam gain,
selecting different Tx beams for the PRACH transmission and the first PRACH retransmission; and
using the same transmission power to perform the PRACH transmission and the first PRACH retransmission.

21. The method of claim 13, further comprising:
when the power ramping step is greater than the beam gain,
selecting the same Tx beam for the PRACH transmission and the first PRACH retransmission; and
increasing a transmission power which is used for the PRACH transmission to perform the first PRACH retransmission.

22. The method of claim 13, further comprising:
when the number of times to ramp up to the maximum transmission power for the power ramping step and the estimated path loss is greater than the number of Tx beams,
selecting different Tx beams for the PRACH transmission and the first PRACH retransmission, and
using the same transmission power to perform the PRACH transmission and the first PRACH retransmission.

23. The method of claim 13, further comprising:
when the number of times to ramp up to the maximum transmission power for the power ramping step and the estimated path loss is smaller than the number of Tx beams,
selecting the same Tx beam for the PRACH transmission and the first PRACH retransmission, and
increasing a transmission power which is used for the PRACH transmission to perform the first PRACH retransmission.

24. The method of claim 13, further comprising:
when the UE has reached the maximum transmission power,
selecting different Tx beams for the PRACH transmission and the first PRACH retransmission, and
using the same transmission power to perform the PRACH transmission and the first PRACH retransmission.
